(19) United States
(12) Patent Application Publication
(10) Pub. No.: US 2025/0348498 A1
(43) Pub. Date: Nov. 13, 2025

(54) PROVIDING CONTEXT FOR AN IMAGE

(71) Applicant: Google LLC, Mountain View, CA (US)

(72) Inventors: Nidhi K. Hebbar, Brooklyn, NY (US); Michael Edward Flaster, Menlo Park, CA (US); John Francis Hebert, Seattle, WA (US); Fernando Kiyoyuki Inakuko, Long Island City, NY (US)

(21) Appl. No.: 19/201,748

(22) Filed: May 7, 2025

Related U.S. Application Data
(60) Provisional application No. 63/644,327, filed on May 8, 2024.

(51) Int. Cl. G06F 16/2457; G06F 16/532; G06F 16/93

(52) U.S. Cl. CPC G06F 16/24578; G06F 16/532; G06F 16/93

(57) ABSTRACT

A method may generate a context query for a query image based on a source document associated with the query image. A method may determine candidate documents including documents with images semantically similar to the query image from an image index and documents responsive to the context query from a document index. A method may rank the candidate documents based on similarity to the context query to generate highest ranking candidate documents. A method may provide information about the highest ranking candidate documents and information relating to a first appearance of the query image.

### CROSS-REFERENCE TO RELATED APPLICATION

This application claims priority to U.S. Provisional Patent Application No. 63/644,327, filed on May 8, 2024, entitled “PROVIDING CONTEXT FOR AN IMAGE”, the disclosure of which is incorporated by reference herein in its entirety.

### BACKGROUND

Search engines can return documents responsive to a query. The query can be a text query or an image query.

### SUMMARY

This disclosure relates to generating search results that help assess the context, provenance, and/or credibility of images. This can include providing information about the image itself, such as when the image and/or similar images were first indexed, whether the image is an AI-Generated image, etc. This can include providing information on other documents (e.g., webpages) that have used or characterized the image, etc. This can include an indication of the provenance (domains) of the first appearances. This can include other places the image has appeared, including news, social media, stock image, and fact checking sites.

The details of one or more implementations are set forth in the accompanying drawings and the description below. Other features will be apparent from the description and drawings, and from the claims.

In some aspects, the techniques described herein relate to a method including: generating a context query for a query image based on a source document associated with the query image; determining candidate documents including documents with images semantically similar to the query image from an image index and documents responsive to the context query from a document index; ranking the candidate documents based on similarity to the context query to generate highest ranking candidate documents; and providing information about the highest ranking candidate documents and information relating to a first appearance of the query image.

In some aspects, the techniques described herein relate to a method including: receiving a request for context about an image; providing the image to an image context service; receiving a search result from the image context service in response to providing the image, the search result being based on a ranking of documents that have images semantically or visually similar to the image and a relevance to a context query related to the image; and displaying the image and the search result.

In some aspects, the techniques described herein relate to a method including: generating a context query for a query image from terms describing the query image that are obtained from a generative model provided the query image as input; identifying candidate documents responsive to the context query from a document index; ranking the candidate documents based on similarity to the context query to identify highest ranking candidate documents; and providing information about the query image based on the highest ranking candidate documents.

In some aspects, the techniques described herein relate to a method including: generating a first representation of semantic meaning of a query image from a first model provided the query image as input; identifying a second image that is similar to the query image, the second image being associated with a second representation of semantic meaning; and clustering the first representation and the second representation to generate a semantic cluster; and generating a context query based on a description term representing the semantic cluster; identifying candidate documents responsive to the context query from a document index; ranking the candidate documents based on similarity to the context query to identify highest ranking candidate documents; and providing information about the query image based on the highest ranking candidate documents.

### BRIEF DESCRIPTION OF THE DRAWINGS

FIG. 1 is a diagram that illustrates an example environment in which improved techniques described herein may be implemented.

FIG. 2 is a diagram that illustrates an example method to determine a context query where the query image lacks a source document, according to disclosed implementations.

FIG. 3 is a diagram that illustrates an example image context system, according to disclosed implementations.

FIG. 4 is a diagram that illustrates an example method for identifying context information for a query image, according to disclosed implementations.

FIG. 5 is a diagram that illustrates an example method for determining candidate context documents and scoring candidate context documents against the context query, according to disclosed implementations.

FIG. 6 is a diagram that illustrates an example method for generating a context query, according to disclosed implementations.

FIG. 7 is an example user interface displaying context information for a query image, according to disclosed implementations.

FIGS. 8A and 8B illustrate example user interfaces displaying a query image in a source document and context information for the query image, according to disclosed implementations.

FIG. 9A illustrates an example user interface for initiating an image context search from a source document, according to disclosed implementations.

FIG. 9B illustrates an example user interface for initiating an image context search without a source document, according to disclosed implementations.

FIG. 10 is a diagram that illustrates an example of a distributed computer device that can be used to implement the described techniques.

### DETAILED DESCRIPTION

Disclosed implementations relate to a service that provides context for an image. Users may have questions about objects that they see in the environment around them that they have no context to understand. Users may have questions about images they encounter while browsing online. Many users believe they see fake or misleading information at least weekly. Other users worry about their friends and family falling for misinformation, including AI-generated images.

Present image searching may be used to find similar images to a target image, referred to as a query image herein. Visually similar images do not necessarily provide the context a user may be seeking about a query image, however. If semantic knowledge about aspects in a query image is available, it is also possible to identify semantically similar images or documents (e.g., for a shopping domain). In many situations a query image may not be associated with enough context to facilitate a helpful semantic search, such as when a user captures a scene with their own smart phone camera. A user may want to know more about a query image than they can determine with the background information available.

Accordingly, a technical problem not addressed by current image searches is how to identify resources to provide more in-depth context about a query image when little to no information is known about the query image. For example, a user may desire more context about a query image captured with a smartphone. Moreover, no current searching methods attempt to provide information to help evaluate the source of a query image or how reputable sources have discussed the image.

Implementations provide a technical solution to this technical problem by generating a context query that may be used to identify further information about the query image using other documents. The context query includes a combination of terms describing aspects of the query image. Some implementations provide the technical solution of generating a context query for a query image from an online document associated with the query image (e.g., a webpage, PDF, etc.) that has already been indexed by a search engine. The online document may be referred to as the source document. One or more salient terms from the source document may be used to generate the context query.

Some implementations provide system that may use the context query with information from the search index and from an image index generated in conjunction with the search index, to identify candidate documents. Candidate documents may include any combination of images that are semantically and/or visually similar to the image and documents relevant to the context query for the query image and the source document. At least some candidate documents are scored (ranked) against a context query to determine their relevance to the context (background) of the image.

The context query may be combination of terms describing aspects of the image. The context query may be a combination of terms describing the image and terms describing the source document. The context query may be a combination of terms describing the image and terms describing similar images. This may enable the ranking to match the context of the image, not just the content of the image, or in other words, documents with potentially less-similar images but better background/context can become higher ranked than documents with semantically or visually similar images. In some implementations, an additional service that connects images to fact checks may be used in determining the candidate documents.

Some implementations provide context for a query image that is provided by a user, i.e., which is not associated with a source document that has been indexed. Such images can be provided by the user's camera (e.g., from a mobile or AR environment), from an uploaded image, from a shared image (e.g., from a text message or email), from a newly posted website that has not been crawled and indexed yet, etc. In such implementations the context query may be generated from salient terms for the image and terms provided by the user. In such implementations, the context query may be generated from salient terms for the image and salient terms from similar images. An image query that lacks the source document can be from an image search application that enables a user to provide an image from a camera, upload an image, or select a portion of an image to serve as the query.

For example, the context query may be generated by executing a model, for example a generative model, using the query image as input to obtain a first set of terms describing aspects of the query image. In examples, the model may return an embedding representing the query image that may be tokenized to obtain the first set of terms. In examples, images that are visually or semantically similar to the query image may be further identified using the embedding and/or the first set of terms. The visually similar images may be associated with a second set of terms, which may be combined with the first set of terms to generate the context query. Implementations further include identifying a group of candidate documents using the context query to identify documents semantically related to the image, and/or documents that include images similar (e.g., visually or semantically similar) to the query image. Once identified, the candidate documents may then be filtered and/or ranked. The ranking may be performed by determining the similarity between the candidate documents and the context query.

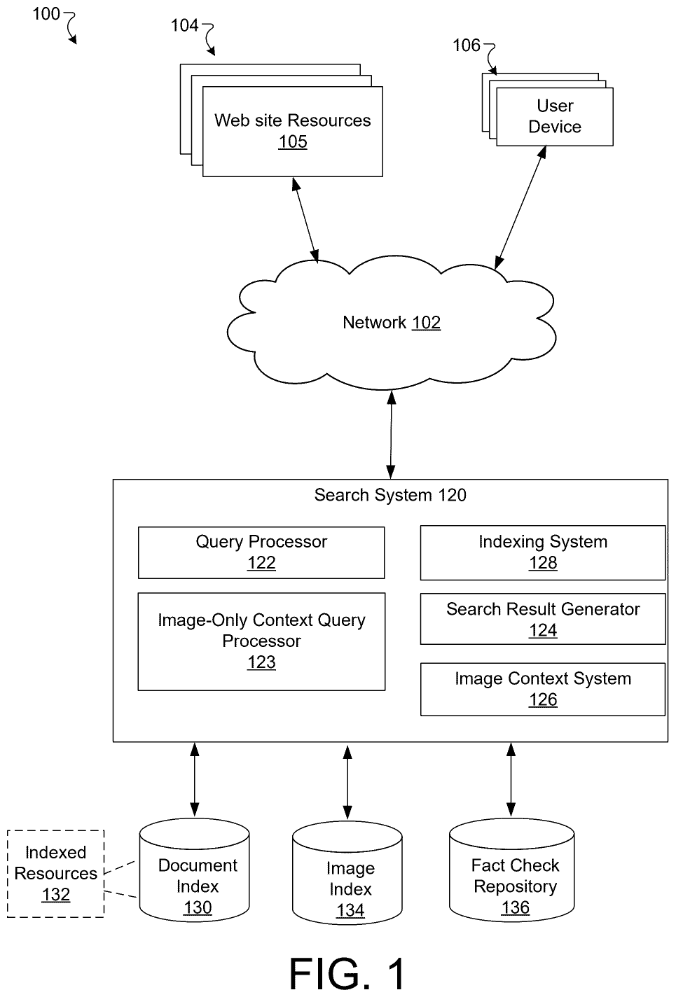

FIG. 1 is a diagram that illustrates an example environment 100 in which improved techniques described herein may be implemented. In the example of FIG. 1, a search result generator 124 of a search system 120 includes (e.g., uses, has access to) an image context system 126. In the example of FIG. 1, the search system 120 is described as an Internet search engine, but implementations are not limited to Internet search engines and the disclosed techniques can be applied in any type of search system that responds to queries for resources. As used herein, documents can refer to any text-based content accessible to a search engine, such as webpages, portable document format (PDF) files, plain text files, metadata describing images, etc. As used herein, resources can refer to any content accessible to a search engine. Thus, resources include webpages, images, documents, media, metadata, etc.

With continued reference to FIG. 1, a search system 120 provides search services. The example environment 100 includes a network 102, e.g., a local area network (LAN), wide area network (WAN), the Internet, or a combination thereof, connects web sites 104, user devices 106, and the search system 120. In some examples, the network 102 can be accessed over a wired and/or a wireless communications link. For example, mobile computing devices, such as smartphones can utilize a cellular network to access the web sites 104 and/or the search system 120. In some examples, the search system 120 can access the web site 104 via the Internet. The environment 100 may include millions of web sites 104 and user devices 106. In some implementations, the indexing system 128, query processor 122, image-only context query processor 123, and search result generator 124 may be co-located, e.g., at a server, which may be a distributed server. In some implementations, one or more of the indexing system 128, the query processor 122, image-only context query processor 123, and/or the search result generator 124 may be remote from but communicatively coupled with each other, e.g., at different servers that communicate with each other.

In some examples, a web site 104 is provided as one or more resources 105 associated with an identifier, such as domain name, and hosted by one or more servers. An example web site is a collection of web pages formatted in an appropriate machine-readable language, e.g., hypertext markup language (HTML), that can contain text, images, multimedia content, and programming elements, e.g., scripts. Each web site 104 is maintained by a publisher, e.g., an entity that manages and/or owns the web site. Web site resources 105 can be static or dynamic. In some examples, a resource 105 is data provided over the network 102 and that is associated with a resource address, e.g., a uniform resource locator (URL). In some examples, resources 105 that can be provided by a web site 104 include web pages, word processing documents, and portable document format (PDF) documents, images, video, and feed sources, among other appropriate digital content. The resources 105 can include content, e.g., words, phrases, images and sounds and may include embedded information, e.g., meta information and hyperlinks, and/or embedded instructions, e.g., scripts.

In some examples, a user device 106 is an electronic device that is under control of a user and is capable of requesting and receiving resources 105 over the network 102. Example user devices 106 include personal computers, mobile computing devices, e.g., smartphones, wearable devices (glasses, AR/VR headsets, etc.), and/or tablet computing devices that can send and receive data over the network 102. As used throughout this document, the term mobile computing device (“mobile device”) refers to a user device that is configured to communicate over a communications network and is easily portable, e.g., designed to be taken from one location to another. A smartphone, e.g., a phone that is enabled to communicate over the Internet, is an example of a mobile device, as are wearables and other smart devices such as smart speakers. A user device 106 typically includes a user application, e.g., a web browser, to facilitate the sending and receiving of data over the network 102.

The user device 106 may include, among other things, a network interface, one or more processing units, memory, and a display interface. The network interface can include, for example, Ethernet adaptors, Token Ring adaptors, and the like, for converting electronic and/or optical signals received from the network to electronic form for use by the user device 106. The set of processing units include one or more processing chips and/or assemblies. The memory includes both volatile memory (e.g., RAM) and non-volatile memory, such as one or more ROMs, disk drives, solid state drives, and the like. The set of processing units and the memory together form controlling circuitry, which is configured and arranged to carry out various methods and functions as described herein. The display interface is configured to provide data to a display device for rendering and display to a user.

In some examples, to facilitate searching of resources 105, the search system 120 includes an indexing system 128 identifies the resources 105 by crawling and indexing the resources 105 provided on web sites 104. The indexing system 128 may index data about and content of the resources 105, generating document index 130. In some implementations, the fetched and indexed resources 105 may be stored as indexed resources 132. The indexed resources 132 may include metadata (information) about the resource, including historical information, such as the first date a resource was indexed, the last date the resource was updated, etc. Where the resource represents an image, the information stored in the indexed resources 132 may include terms describing the image. For example, as part of indexing the image a process may be used to generate a list of terms most salient to the image. In some implementations, the information stored in the indexed resources 132 for an image may include an embedding of the image. The embedding may represent aspects of the image used to determine similarity with other images. Such an embedding can be used to determine visual similarity.

In some implementations, the document index 130 and/or the indexed resources 132 may be stored at the search system 120. In some implementations, the document index 130 and/or the indexed resources 132 may be accessible by the search system 120. In some implementations (not shown), the search system 120 may have access to a separate fact repository that can be accessed to provide factual responses to a query and/or to help with ranking resources responsive to a query. The document index 130 can include an inverted index. An inverted index stores posting lists, where each posting list includes a list of document identifiers that include a particular term (a word, a phrase, or a portion thereof). In some implementations, the posting list includes an indication of the relevance of that term to the document. Thus, the document index 130 provides an indication of which terms are most salient to a particular document in the indexed resources 132.

The search system 120 may include (have access to), an image index 134. The image index 134 is similar to the document index 130 in that it may store posting lists, where each posting list associates a term with images described by that term. As with documents, the relevance (saliency) of a term to a particular image may be started in the image index 134. This type of index may enable semantically similar images to be identified, even if such images are not necessarily visually similar. However, images that have a main entity that is visually similar but with large differences in semantics (e.g., differences in prominent text, differences in background) may not be identified as highly relevant to each other.

In some implementations, the search system 120 may include or have access to a fact-check repository 136. The fact-check repository 136 may represent a service that finds matching images connected to fact checks, partially based on webmaster markup. In some implementations, the fact-check repository 136 may be wholly or partially curated by users. This index may represent a small proportion of images, but can be highly relevant to image context. The fact-check repository 136 can be a service accessible to the search system 120 via an API.

The user devices 106 submit search queries to the search system 120. In some examples, a user device 106 can include one or more input modalities. Example input modalities can include a keyboard, a touchscreen, a mouse, a stylus, and/or a microphone. For example, a user can use a keyboard and/or touchscreen to type in a search query. As another example, a user can speak a search query, the user speech being captured through the microphone, and processed through speech recognition to provide the search query.

The search system 120 may include query processor 122, image-only context query processor 123, and/or search result generator 124 for responding to search queries. In response to receiving a search query, the query processor 122 may process (parse) the query using query processor 123 to generate a context query. The context query may include terms that describe aspects of the query image, including but not limited to objects, environmental aspects, scenes, and concepts. The content query may be used to access the document index 130 and/or the image index 134 and identify resources 105 that are relevant to the search query, e.g., have at least a minimum specified relevance score for the search query and/or have a relevance score that makes the resource included in a requested number (e.g., 100, 700, etc.) of highest-scoring (most responsive) resources. The query processor 122, the image-only context query processor 123, and the search result generator 124 of FIG. 1 may represent different query processors, context query processors, and/or search result generators. For example, the query processor for a search of the image index 134 may receive a context query including a context query that includes terms describe the query image and/or generate an embedding of the query image. The context query may be used to find responsive images from the image index 134. Thus, a query to the image index 134 may return semantically similar images and/or visually similar images. In disclosed implementations, the image context system 126 may use the query processor 122, the image-only context query processor 123 and/or the search result generator 124 to respond to an image context query.

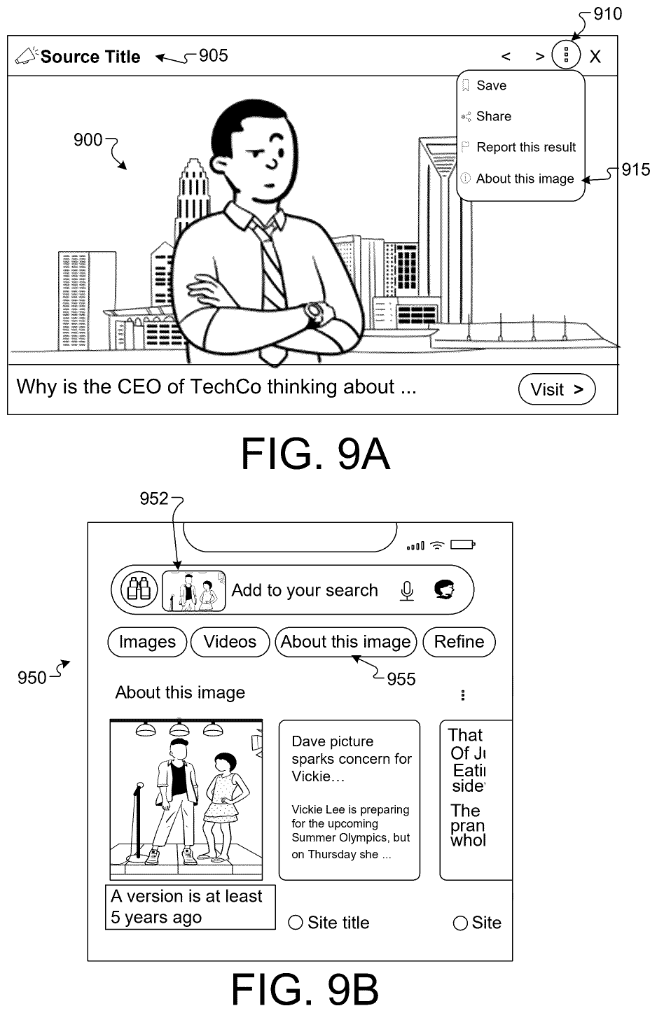

The image context query may be submitted via a user interface, such as the user interfaces described in FIG. 9A and 9B below.

The search system 120 may identify the resources 132 that are responsive to a query and generate a search result page. The search result page includes search results and can include other content, such as ads, entity (knowledge panels), onebox answers, entity attribute lists (e.g., songs, movie titles, etc.), short answers, generated responses (e.g., from a large language model), other types of rich results, links to limit the search to a particular resource type (e.g., images, travel, shopping, news, videos, etc.), other suggested searches, etc. Each search result corresponds to a resource available via a network, e.g., via a URL/URI/etc. The resources represented by search results are determined by the search result generator 124 to be top ranked resources that are responsive to the query. A resource is the top-ranked resource when it has a relevance score (e.g., an information retrieval score) that is higher than any other resource. Top-ranked resources may include resources with a relevance score above a relevance threshold or a predetermined number of the highest-ranked resources. A search result page may include a subset of search results initially, with additional search results (e.g., for lower-ranked resources) being shown in response to a user selecting a next page of results (e.g., either by selecting a ‘next page’ control or by continuous scrolling, where new search results are generated after a user reaches and end of a currently displayed list but continues to scroll).

Each search result includes a link to a corresponding resource. Put another way, each search result represents/is associated with a resource. The search result can include additional information, such as a title from the resource, a portion of text obtained from the content of the resource (e.g., a snippet), an image associated with the resource, etc., and/or other information relevant to the resource and/or the query, as determined by the search result generator 124 of the search system 120. In some implementations, the search result may include a snippet from the resource and an identifier for the resource. For example, where the query was issued from a device or application that received the user query via voice, the search result may be a snippet that can be presented via a speaker of the user device 106. The search result generator 124 may include a component configured to format the search result page for display or output on a user device 106. The search system 120 returns the search result page to the query requestor. For a query submitted by a user device 106, the search result page is returned to the user device 106 for display, e.g., within a browser, on the user device 106.

In disclosed implementations, the search result generator 124 includes or is accessible by the image context system 126. The image context system 126 may use the search result generator 124 to identify resources responsive to different queries and may filter and re-rank (score) resources for responding to the image context query. The search result generator 124 can generate a snippet for one or more of the responsive resources. Likewise, the query processor 122 may be accessible by the image context system 126 to perform pre-processing activities on the query image, such as generating salient terms or an embedding for the query image.

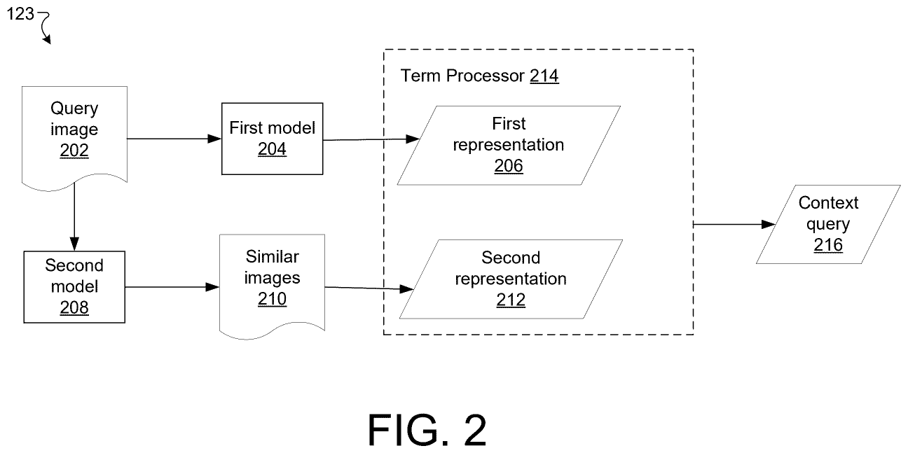

FIG. 2 is a flow diagram of image-only context query processor 123, according to examples. Image-only context query processor 123 may determine a context query based on a query image when the query image lacks a related source document, according to disclosed implementations. While the example of image-only context query processor 123 depicted in FIG. 2 includes two models, in examples the first and second model may be the same model. In examples, the first model and/or the second model may include additional models. In examples, the first model and the second model may include any type of neural network, generative, or artificial intelligence model.

The flow diagram depicted in FIG. 2 may begin when a first model 204 receives the query image 202 and generates first representation 206. In examples, the first model 204 may be a generative model, which may be executed with a prompt requesting terms to describe the semantic meaning of one or more aspects of the query image 202. In examples, the first representation 206 may be an embedding, a high-dimensional space representing the semantic meaning of aspects in the query image 202. The embedding may be tokenized to identify one or more terms associated with first representation 206 of the query image 202. In examples, the first representation 206 may include the one or more terms associated with an embedding. The first representation 206 may be used to generate a context query 216.

In examples, a second model 208 may be executed using the query image 202 as input to generate similar image 210. In examples, similar image 210 may mean a visually similar and/or semantically similar images 210. In examples, similar images 210 may include more than one image. Similar images 210 may be associated with one or more instances of second representation 212, which describes the semantic meaning of the similar images 210. In examples, second representation 212 may be an embedding or one or more terms. In an example, second model 208 may access the image index 134 to determine the second representation 212 for the similar image 210.

A term processor 214 may next be executed using first representation 206 and second representation 212 as inputs. In examples, the first representation 206 describing the semantic meaning of the query image 202 and/or the second representation 212 describing the semantic meaning of the similar images 210 may be used to generate one or more semantic clusters. In examples, the first representation 206 and/or second representation 212 may be clustered by numerically aggregating embeddings or aggregating terms associated with those embeddings according to generate clusters of semantic meaning. In examples, any clustering algorithm may be used, to generate the one or more semantic clusters. Once semantic clusters are identified, a descriptive term representing the highest ranked semantic cluster may be included in the context query.

To generate the context query 216, term processor 214 may further weight semantic concepts represented in the first representation 206 and/or the second representation 212. For example, it may be determined that a first semantic cluster relates to a first number of the first terms and the second terms and that a second semantic cluster relates to a second number of the first terms and the second terms, the second number being lower than the first number. In response, the first semantic cluster may be weighted higher than the second semantic cluster for inclusion in the context query 216.

Although not illustrated in FIG. 2, in examples where the query image 202 is associated with a source document, image-only context query processor 123 may determine the context query 216 in part based on salient terms identified from the source document. The salient terms are terms considered most relevant to the document and may in examples be determined by indexing system 128, when the source document is added to the document index 130. Image-only context query processor 123 may also determine the context query 216 from terms that describe aspects of the query image 202. The terms that describe the query image can be obtained from an index. To be clear, image-only context query processor 123 may execute using any combination of terms reflecting semantic meaning of the query image 202 received from the source document, the query image 202 itself, or similar images 210.

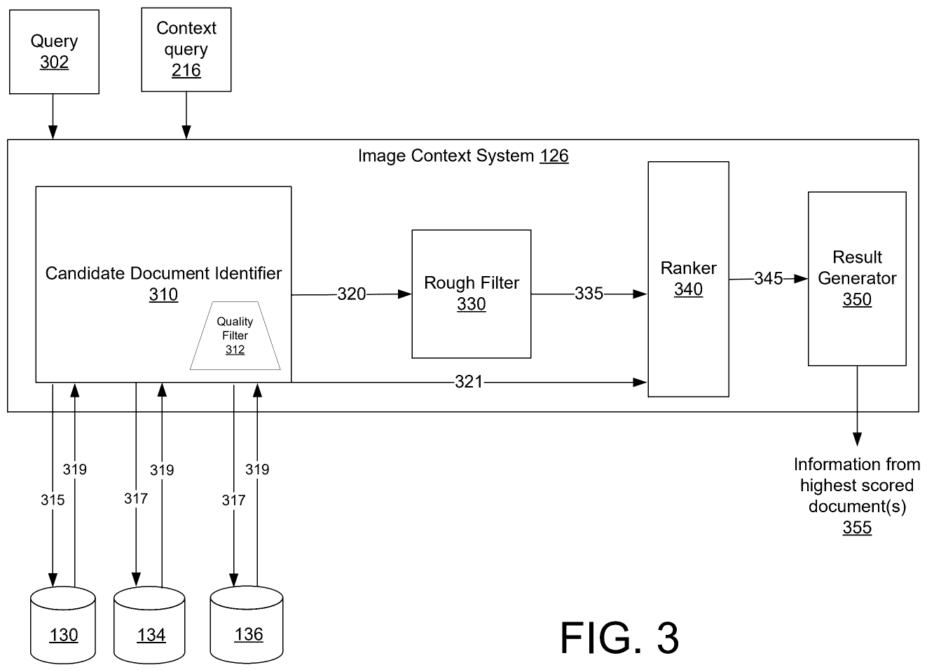

FIG. 3 is a diagram that illustrates an example image context system 126, according to disclosed implementations. In some implementations, the image context system 126 is configured to identify resources that help provide context information for a given image, i.e., the query image, rather than return semantically or visually similar images. The context information can include information about when the image first appeared in the index. The context information can include information identifying the image as generated by an AI. The context information can include news articles about the image, e.g., information from websites determined to have sufficient quality (e.g., using a PageRank score). The context information can include fact checks related to the image. The context information can include whether the image is available as a stock image. This can be especially helpful for identify webpages claiming to include an image of a particular person, but instead includes a stock photo.

The image context system 126 operates on a query 302 that identifies an image. The image identified by the query 302 is referred to as the query image. The query 302 may identify an image that is in the indexed resources 132. The query 302 may identify an image resource locator. The query 302 may include the image file (i.e., the image itself). In some implementations, the query 302 may also include a source document identifier. The source document identifier may identify a document in the indexed resources 132. The image context system 126 can include candidate document identifier 310. The candidate document identifier 310 is configured to identify candidate documents that are associated with the query image (i.e., the image identified by the query 302).

Although illustrated as part of the image context system 126 in FIG. 3, as discussed above, one or more components may be separate from the image context system 126 but accessible to the image context system 126, e.g., via an API call. For example, the candidate document identifier 310, the rough filter 330, the ranker 340, and/or the result generator 350 may be, or may use, services provided by the search system 120. Thus, for example, the candidate document identifier 310 may use the query processor 122 and/or the search result generator 124 to generate a context query, identify documents responsive to the context query, identify the terms describing the query image, generate an embedding for the query image, generate a search result for a responsive document, etc. Put another way, the image context system 126 may use existing processes for certain functions.

In some implementations, the candidate document identifier 310 receives the query 302 and the context query 216 relating to the query 302, using any of the methods described herein. Context query 216 may then be used with an image index, for example image index 134, to determine the semantic meaning of one or more objects in the image.

In some implementations, the search system 120 may already have determined the salient terms for an image that appears in an indexed document (e.g., a document in the indexed resources 132). Where the query 302 identifies a source document, the salient terms for the image may be retrieved rather than generated.

The candidate document identifier 310 may query the document index 130 and the image index 134 to identify candidate documents. The candidate document identifier 310 uses the context query 216 to identify responsive documents from the document index 130. In some implementations, a predetermined number of responsive documents are identified. In some implementations, an API that searches the document index 130 may be provided with the context query 216 and may provide, in return, candidate documents 319. In some implementations, the candidate document identifier 310 may include a quality filter 312. The quality filter 312 may be used to filter out documents with a quality score below a document quality threshold. The quality score may reflect a score assigned to the document by the indexing system 128. PageRank is an example of a quality score for a document. Documents in the candidate documents 319 but that fail to meet the quality filter 312 are filtered out of the candidate documents 320 provided to the rough filter 330. The quality filter 312 ensures that context results are selected from more reliable sources. Each candidate document 320 is also returned with a respective relevance score (e.g., information retrieval score), which reflects the document's relevance to the context query 216.

The candidate document identifier 310 may also identify candidate documents 319 from the image index 134 based on a context query 216 that includes terms describing the query image. The candidate documents 319 identified using image index 134 may be used to identify the highest ranked candidate documents, or those that are most similar to the query 302. Candidate documents 319 identified using the image index 134 may further be used to identify stock-images and/or filter out candidate documents that are not similar enough to the query image 202.

In response to the image query 317, the candidate document identifier 310 may receive a list of images that are responsive to the image query 317 and a list of documents that each responsive image appears in. Each unique image, or image and document pair may be considered a candidate document 319. The image may be given a respective relevance score, which reflects the image's relevance to the image query 317. Some of the candidate documents 319 from the image index 134 may be filtered out of the candidate documents 320, which are provided to the rough filter 330. Each document of the candidate documents 319 has an associated quality score, as described above, and the quality filter 312 may filter out from the candidate documents 320 any candidate documents 319 where the quality score fails to meet the document quality threshold. In addition, in some implementations, where an image is associated with more than one document in the candidate documents 319, only the document with the highest quality score is kept for the candidate documents 320. In some implementations, the 310 obtains hundreds of candidate documents 319 (e.g., 300, 700, etc.) from the image index 134.

Where a fact-check repository 136 is accessible to the image context system 126, the candidate document identifier 310 may also query the fact-check repository 136 using the image query 317 and or the query image itself. The fact-check repository 136 may return a list of candidate documents 319 that include the query image. In some implementations, the candidate documents 319 from the fact-check repository 136 are filtered using the quality filter 312 before being included in the candidate documents 320. In some implementations, all documents from the fact-check repository 136 are considered of sufficient quality that the quality filter 312 is not applied to candidate documents 319 from the fact-check repository 136. In other words, in some implementations, all candidate documents 319 from the fact-check repository 136 are included in the candidate documents 320.

In some implementations, the candidate document identifier 310 may identify candidate documents 321. Candidate documents 321 may be documents that were identified using the image index 134 (e.g., candidate documents 319 identified from the image index 134) but that are also highly responsive to a stock-image query. The stock-image query may be a query that searches for “stock photo” or “stock image”. Because the candidate documents 319 from the image index 134 are already known to be relevant to the query image, these documents can be evaluated for relevance to “stock photo” or “stock image”. Candidate documents 319 that are relevant (e.g., have a relevance score that meets a stock image relevance threshold), may be included in the candidate documents 321. In some implementations, a candidate document is only included in the candidate documents 321 when the image in the candidate document meets a semantic or visual similarity threshold with the query image 202. In examples, the similarity may be determined based on an embedding space, as described herein. Unlike candidate documents 320, candidate documents 321 are not evaluated against the context query 216, but are included in and ordered with the scored candidate documents 345. The candidate documents 321 help the image context system 126 identify images that are stock images even if the source document does not present the image as a stock image.

The rough filter 330 is configured to further filter the candidate documents 320 and adjust the relevance scores of some of the candidate documents 320. In some implementations, the rough filter 330 may keep a predetermined number of the candidate documents 320. For example, if the candidate documents 320 include 10 documents from the fact-check repository 136, 75 documents from the document index 130, and 750 documents from the image index 134, the candidate documents 320 may be culled (filtered) to the 300 documents with highest. In some implementations, this occurs after boosting the relevance scores based on visual similarity with the query image, as explained below. In some implementations, this can occur after boosting the relevance scores based on visual similarity.

The rough filter 330 may also boost the respective relevance scores of some of the candidate documents 320. In some implementations, a boost may be determined for any candidate document in the candidate documents 320. In some implementations, a boost may be determined for any candidate document in the candidate documents 320 that has a respective relevance that fails to meet a minimum relevance. In other words, if a candidate document has a relevance score that is sufficiently high, the image context system 126 may not try to boost the relevance score. However, for other candidate documents the rough filter 330 may use a visual image similarity to boost the respective relevance score of a candidate document.

To determine visual similarity, the query image and the image in the candidate document may be converted to an embedding space. In examples, this embedding space may be part of the image index 134. A similarity between the query image and the image in the candidate document may be computed using the one or more embeddings using known techniques. The more aspects from the embedding space that match between the query image and the image from the candidate document, the more visually similar the two images are.

The similarity between the two images may be used to boost the respective relevance score for the candidate document. Thus, documents with images that lack high semantic similarity to the query image but that have high visual similarity may receive a boost to their relevance score. In some implementations, after boosting is completed, candidate documents with respective relevance scores that fail to meet a minimum relevance threshold may be filtered out (dropped from the candidate documents). The rough filter 330 sends remaining candidate documents, i.e., filtered candidate documents 335, to the ranker 340 for scoring against the context query.

The ranker 340 evaluates the filtered candidate documents 335 against the context query 216. Put another way, the ranker 340 determines a respective relevance of each document in the filtered candidate documents 335 to the context query 216. This ensures that highly-ranked documents provide context for the query image and not just documents with images similar to the query image. Put another way, the system does not simply try to provide information about the pixels (as conventional image searches do), but about the context in which the query image is being hosted. For some images these might be the same thing, but for images of popular people or events these could be very different.

For example, a query image may depict Actor A and an unknown individual, but because Actor A is famous there are many images of Actor A, so an image search provides little context for this exact image. Adding additional context from the source document, e.g., that the unknown individual was incorrectly identified as Singer B, helps surface documents that mention Singer B and Actor A and an image similar to the one with the unknown individual. These could be, for example, news articles about how Singer B was misidentified in the image. These news articles would not be surfaced in response to a conventional image search.

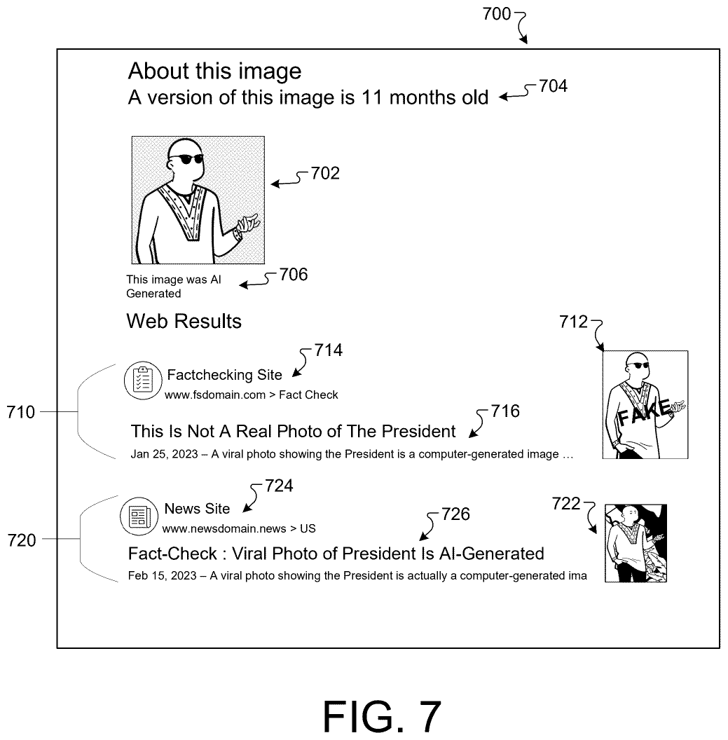

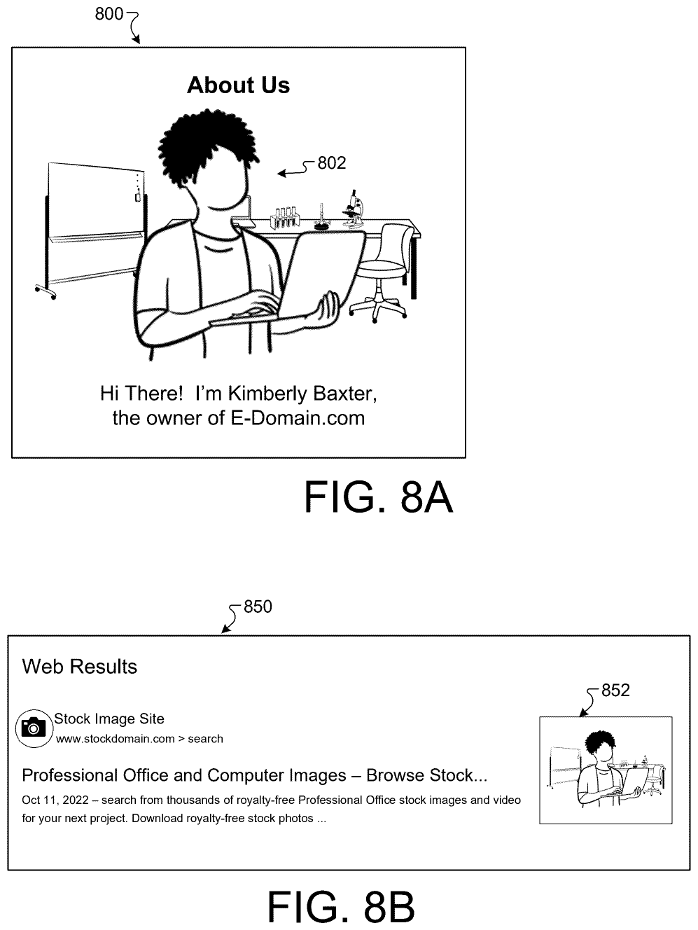

The ranker 340 assigns a new (second) respective relevance score to each of the filtered candidate documents 335. This new (or second) respective relevance score represents the relevance of the candidate document to the context query. Thus, the ranker 340 provides scored candidate documents 345. The scored candidate documents 345 may be combined with the candidate documents 321 (if any) from the stock-image query. These candidate documents are ordered by relevance score and the top-scoring (highest scoring) documents are selected for use in an image context interface, such as the interfaces illustrated in FIGS. 7 and 8B. The result generator 350 may generate the image context interface using information from the highest scored documents 355. This information can include titles from the highest scored documents 355, the similar images from the highest scored documents 355, and/or snippets generated for the highest scored documents 355. In some implementations, additional information about the query image may be obtained. This information includes an age (e.g., based on a first known indexing date) of the image. This information can include an indication that an image was generated by a generative AI model. This information can include metadata for the image. Example metadata for the image can include any metadata defined by an image standard. The IPTC Photo Metadata Standard is one example of such a standard.

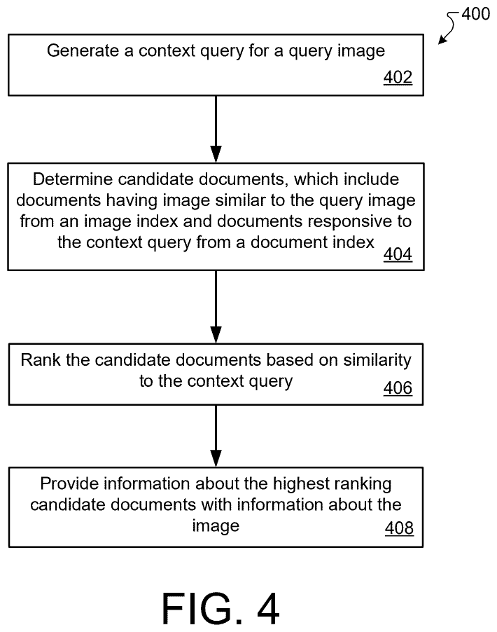

FIG. 4 is a diagram that illustrates an example method 400 for identifying context information for a query image, according to disclosed implementations. Method 400 may be executed in an environment, such as environment 100. In some implementations, one or more of the method steps may be executed by a system, such as image context system 126 of FIG. 3. Not all steps need to be performed in some implementations. Additionally, the method steps can be performed in an order other than that depicted in FIG. 4.

Method 400 may begin with step 402. In step 402, a context query may be generated for a query image. For example, the context query may be generated based on an embedding of the query image. The context query 216 may be generated based on salient terms from a source document associated with the query image. The context query 216 may be generated based on terms provided by the user. The context query may be generated based on terms describing aspects of similar images, as described above.

Method 400 may continue with step 404. In step 404, candidate documents may be determined, including documents having images similar to the query image from an image index and documents responsive to the context query from a document index. For example, candidate documents 320 may be determined based on image query 317 from image index 134, as described above.

Method 400 may continue with step 406. In step 406, the candidate documents may be ranked based on similarity of the context query. For example, ranker 340 may rank filtered candidate documents 335, as described above.

Method 400 may continue with step 408. In step 408, information may be provided about the highest ranking candidate document with information about the image. For example result generator 350 may provide highest scored documents 355, as described above.

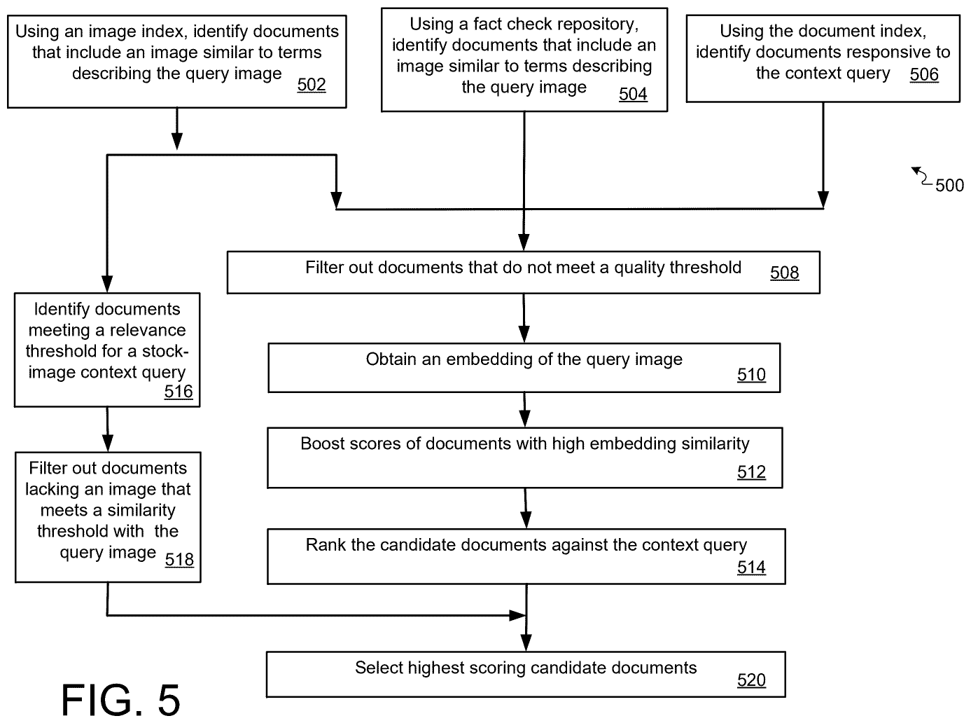

FIG. 5 is a diagram that illustrates an example method 500 for determining candidate context documents and scoring candidate context documents against the context query, according to disclosed implementations. Method 500 may be executed in an environment, such as environment 100. In some implementations, one or more of the method steps may be executed by a system, such as image context system 126 of FIG. 1. In some implementations, method 500 may represent steps 404 and 406 of FIG. 4. Not all steps need to be performed in some implementations. Additionally, the method steps can be performed in an order other than that depicted in FIG. 5.

In examples, method 500 may begin with step 502. In step 502, an image index may be used to identify documents that include an image similar to terms describing the query image. For example, the image index 134 may be used to identify candidate documents 319 that include an image similar to a context query associated with image query 317, as described above.

Method 500 may include step 504. In step 504, a fact check repository may be used to identify documents that include an image similar to terms describing the query image. For example, fact-check repository 136 may be used to identify candidate documents 319 that include an image similar to the context query associated with the image query 317, as described above.

Method 500 may include step 506. In step 506, the document index may be used to identify documents responsive to the context query. In examples, the document index 130 may be used to identify candidate documents 319 responsive to the context query 216, as described above.

Method 500 may include step 508. In step 508, documents that do not meet a quality threshold may be filtered out, including any combination of the documents identified in steps 502, 504, and/or 506. For example, quality filter 312 may be used to filter out any candidate documents 319, as described above.

Method 500 may include step 510. In step 510, an embedding of the query image may be obtained. For example, query processor 122 may generate the context query, as described above.

Method 500 may include step 512. In step 512, relevance scores of documents with high embedding similarity may be boosted. The embedding similarity represents a high degree of similarity in semantic meaning between a document and the query image. In examples the semantic meaning of the document and the query image may overlap or be related. For example, rough filter 330 may boost the relevance score of any of candidate documents 320, as described above.

Method 500 may include step 514. In step 514, the candidate documents may be ranked against the context query. For example, the filtered candidate documents 335 may be ranked at ranker 340, as described above.

Method 500 may include step 516. In step 516, documents meeting a relevance threshold may be identified for a stock-image context query, including any combination of the documents identified in steps 502 and 506. For example, candidate documents 321 may be documents that were identified using the image index 134 that are also highly responsive to a stock-image query, as described above.

Method 500 may include step 518. In step 518, documents lacking an image that meets a similarity threshold with the query image may be filtered out. For example, candidate documents 319 that fail to meet the quality filter 312 may be filtered out of the candidate documents 320 provided to the rough filter 330, as described above.

Method 500 may include step 520. In step 520, highest scoring candidate documents may be selected. For example, result generator 350 may generate the image context interface using information from the highest scored documents 355, as described above.

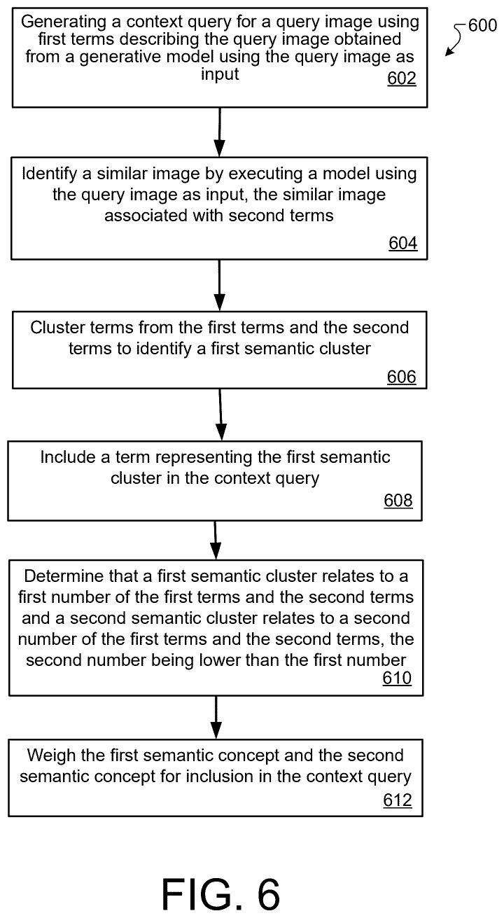

FIG. 6 is a diagram that illustrates an example method 600 for determining a context query, according to disclosed implementations. Method 600 may be executed in an environment, such as environment 100. In some implementations, one or more of the method steps may be executed by a system, such as query processor 122 of FIG. 1. In some implementations, method 600 may represent step 402 of FIG. 4. In some implementations, however, not all steps need to be performed. Additionally, the method steps can be performed in an order other than that depicted in FIG. 6.

Method 600 may begin with step 602. In step 602, a context query may be generated for a query image using first terms describing the query image obtained from a generative model using the query image as input. For example, a context query 216 may be generated for a query image 202 using first representation 206 determined using first model 204 with the query image 202 as input, for example.

Method 600 may continue with step 604. In step 604, a similar image may be identified by executing a model using the query image as input, the visually similar image associated with a second embedding. For example, similar image 210 may be identified by executing second model 208 using query image 202 as input, as described above.

Method 600 may continue with step 606. In step 606, the first terms and the second terms may be clustered to generate a semantic cluster, as described above.

Method 600 may continue with step 608. In step 608, a term representing the first semantic cluster may be included in the context query, as described above.

Method 600 may continue with step 610. In step 610, it may be determined that a first semantic cluster relates to a first number of the first terms and the second terms and a second semantic cluster relates to a second number of the first terms and the second terms, the second number being lower than the first number, as described above.

Method 600 may continue with step 612. In step 612, the first semantic cluster and the second semantic cluster may be weighted for inclusion in the context query, as described above.

FIG. 7 is an example user interface 700 displaying context information for a query image, according to disclosed implementations. The user interface 700 includes a depiction of the query image 702. The user interface 700 may include an indication 704 of the age of the query image 702. The age of the query image 702 may be determined by, e.g., a search system such as search system 120 of FIG. 1. In the example of FIG. 7, the 702 may have been in a document that mentions the unusual appearance of the president. The search system search system 120 may determine an earliest entry in the image index 134 for the query image 702. The user interface 700 may include a generation indicator 706. For images that are determined to be artificially generated, i.e., by a generative AI (artificial intelligence) model, the system may add generation indicator 706. An image may be considered an artificially generated image from metadata associated with the image. For example, some image generation models label themselves as generated using AI. As another example, some image generation models include a watermark embedded in the pixel data that can be used to identify the image as an artificially generated image.

The example of FIG. 7 also includes image context search result 710 and image context search result 720. Image context search result 710 and image context search result 720 illustrate that because the candidate documents were re-scored (re-ranked) against the context query, the search results include documents with images 712 and 722 that are visually similar to the query image 702, but not exact matches, but are highly relevant to the appearance of the President. Appearance (or synonyms of this term) and descriptions of the appearance may have been included in the context query because these aspects are highly relevant to the source document. The image context search results 710 and 720 are provided for the 702 not because the images 712 and 722 are most visually similar to the 702, but because the images are similar and provide (are relevant to) an informative context for the query image 702.

In the example of FIG. 7, the image context search result 710 can represent a search result for a fact-check repository 136. The image context search result 710 can include a source identifier 714. The source identifier 714 can include a title of the source document. The source identifier 714 can include a resource locator of the source document. The image context search result 710 can include a snippet 716. The snippet 716 may be generated using known techniques and represents text extracted from the source document. The image 712 is an image that appears in the source document for the image context search result 710.

Likewise, the 720 can represent a search result for a document index 130 or image index 134. The image context search result 720 can include a source identifier 724. The source identifier 724 can include a title of the source document. The source identifier 724 can include a resource locator of the source document. The image context search result 710 can include a snippet 726. The snippet 726 may be generated using known techniques and represents text extracted from the source document. The image 722 is an image that appears in the source document for the image context search result 720.

FIGS. 8A and 8B illustrate example user interfaces displaying a query image 802 in a source document 800 and context information 850 for the query image 802, according to disclosed implementations. The example of FIGS. 8A and 8B illustrate an implementation that includes a parallel stock-image query to identify documents that include an image 852 similar to the query image 802 and are highly responsive to a stock-image query (e.g., candidate documents 321).

FIGS. 9A and 9B depict an entry point for the image context query via a user interface. In the example of FIG. 9A, the image 900 is provided on an image search result page. In the example of FIG. 9A, selection of the image context menu option 915 (an interactive control) from menu 910 may trigger the image context query. The image context query type in the example of FIG. 9A identifies an image and a document. In FIG. 9A the image identifier identifies image 900 and its source document, which may have a title 905, and which is identified by a resource identifier (e.g., URL). In the example of FIG. 9A, in response to a user selecting the image context menu option 915, the user device may submit a request for image context for the image 900 and source document identifier to the search system 120. The search system 120 will provide the image identifier and source document identifier to the image context system 126. The processing of this request is explained in more detail with respect to FIG. 3.

In the example of FIG. 9B, an interface of an image search application 950 is illustrated. The image search application 950 may include a control 955 (an interactive control) for requesting context for an image. In the image search application 950, the image, e.g., image 952, may or may not have an associated source document. Similar to FIG. 9A, in response to user selection of the control 955, the user device will send an image context query type to the search system 120, which will provide the query to the image context system 126 for processing. The image context system 126 may also be referred to as an image context service.

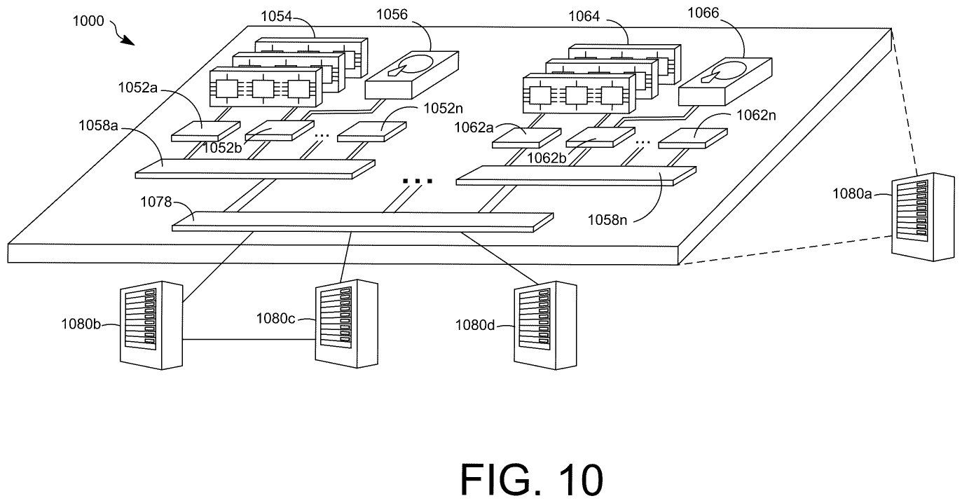

FIG. 10 shows an example of a computing device 1000, which may be search system 120 of FIG. 1, which may be used with the techniques described here. Computing device 1000 is intended to represent various example forms of large-scale data processing devices, such as servers, blade servers, data centers, mainframes, and other large-scale computing devices. Computing device 1000 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 1000 may be a distributed system that includes any number of computing devices 1080 (e.g., 1080a, 1080b, . . . 1080n). Computing devices 1080 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 1080a includes multiple racks (e.g., 1058a, 1058b, . . . , 1058n). Each rack may include one or more processors, such as processors 1052a, 1052b, . . . , 1052n and 1062a, 1062b, . . . , 1062n. The processors may include data processors, network attached storage devices, and other computer-controlled devices. In some implementations, one processor may operate as a master processor and control the scheduling and data distribution tasks. Processors may be interconnected through one or more rack switches 1062a-962n, and one or more racks may be connected through switch 1078. Switch 1078 may handle communications between multiple connected computing devices 1000.

Each rack may include memory, such as memory 1054 and memory 1064, and storage, such as 1056 and 1066. Storage 1056 and 1066 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 1056 or 1066 may be shared between multiple processors, multiple racks, or multiple computing devices and may include a non-transitory computer-readable medium storing instructions executable by one or more of the processors. Memory 1054 and 1064 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 1054 may also be shared between processors 952a-552n. Data structures, such as an index, may be stored, for example, across storage 1056 and memory 1054. Computing device 1000 may include other components not shown, such as controllers, buses, input/output devices, communications modules, etc.

An entire system may be made up of multiple computing devices 1000 communicating with each other. For example, device 1080a may communicate with devices 1080b, 1080c, and 1080d, and these may collectively be known as image context system 126, search result generator 124, indexing system 128, query processor 122, and/or search system 120. Some of the computing devices may be located geographically close to each other, and others may be located geographically distant. The layout of computing device 1000 is an example only and the system may take on other layouts or configurations.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) LCD (liquid crystal display), or LED monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. Moreover, as used herein, ‘a’ or ‘an’ entity may refer to one or more of that entity. Accordingly, implementations can include the following aspects, alone or in combination.

In some aspects, the techniques described herein relate to a method, wherein the candidate documents are first candidate documents and the method further includes: determining, for the documents with images semantically similar to the query image, second candidate documents, the second candidate documents meeting a relevance threshold for a stock-image query; filtering out documents from the second candidate documents in response to determining the documents lack an image that meets a visual similarity threshold with the query image; and including the second candidate documents with the first candidate documents as part of determining highest-ranking documents.

In some aspects, the techniques described herein relate to a method, wherein the candidate documents further include documents from a fact-check repository that include an image similar to the query image.

In some aspects, the techniques described herein relate to a method, wherein the candidate documents have respective first relevance scores and the method further includes: determining, for the candidate documents, respective visual similarity scores based on the query image; and boosting the respective first relevance scores based on the respective visual similarity scores, wherein the highest ranking candidate documents are further ranked based on respective second relevance scores determined based on similarity with the context query and the respective first relevance scores.

In some aspects, the techniques described herein relate to a method, wherein the context query is generated from terms most relevant to the query image.

In some aspects, the techniques described herein relate to a method, wherein the candidate documents are filtered using a document quality threshold prior to ranking.

In some aspects, the techniques described herein relate to a method, wherein a source document associated with the image is provided to the image context service and the source document includes salient terms that are used to generate the context query.

In some aspects, the techniques described herein relate to a method, wherein the ranking is further based on relevance to a stock-image query.

In some aspects, the techniques described herein relate to a method, wherein receiving the request occurs responsive to selection of an interactive control provided on an image search result page that includes the image.

In some aspects, the techniques described herein relate to a method, wherein receiving the request occurs responsive to selection of an interactive control provided on an image search application.

In some aspects, the techniques described herein relate to a method, wherein the terms are first terms, and generating the context query further includes: identifying a second image that is similar to the query image, the second image being associated with second terms; and using the second terms in further generating the context query.

In some aspects, the techniques described herein relate to a method, wherein the second image is visually similar to the query image.

In some aspects, the techniques described herein relate to a method, wherein generating the context query further includes: clustering the first terms and the second terms to generate a semantic cluster; and including a description term representing the semantic cluster in the context query.

In some aspects, the techniques described herein relate to a method, wherein generating the context query further includes: determining that a first semantic cluster relates to a first number of the first terms and the second terms and a second semantic cluster relates to a second number of the first terms and the second terms, the second number being lower than the first number; and weighting the first semantic cluster higher than the second semantic cluster for inclusion in the context query.

In some aspects, the techniques described herein relate to a method, wherein determining the candidate documents further includes identifying documents with images semantically similar to the query image from an image index.

In some aspects, the techniques described herein relate to a method, wherein the candidate documents are first candidate documents and the method further includes: determining, for the first candidate documents with images semantically similar to the query image, second candidate documents, the second candidate documents meeting a relevance threshold for a stock-image query; filtering out documents from the second candidate documents in response to determining the documents lack an image that meets a visual similarity threshold with the query image; and including the second candidate documents with the first candidate documents as part of determining highest-ranking documents.

In some aspects, the techniques described herein relate to a method, wherein the candidate documents further include documents from a fact-check repository that include an image similar to the query image.

In some aspects, the techniques described herein relate to a method, wherein the candidate documents have respective first relevance scores and the method further includes: determining, for the candidate documents, respective visual similarity scores based on the query image; and boosting the respective first relevance scores based on the respective visual similarity scores, wherein the highest ranking candidate documents are further ranked based on respective second relevance scores determined based on similarity with the context query and the respective first relevance scores.

What is claimed is:

1. A method comprising:
generating a context query for a query image based on a source document associated with the query image;
determining candidate documents including documents with images semantically similar to the query image from an image index and documents responsive to the context query from a document index;
ranking the candidate documents based on similarity to the context query to generate highest ranking candidate documents; and
providing information about the highest ranking candidate documents and information relating to a first appearance of the query image.

2. The method of claim 1, wherein the candidate documents are first candidate documents and the method further comprises:
determining, for the documents with images semantically similar to the query image, second candidate documents, the second candidate documents meeting a relevance threshold for a stock-image query;
filtering out documents from the second candidate documents in response to determining the documents lack an image that meets a visual similarity threshold with the query image; and
including the second candidate documents with the first candidate documents as part of determining highest-ranking documents.

3. The method of claim 1, wherein the candidate documents further include documents from a fact-check repository that include an image similar to the query image.

4. The method of claim 1, wherein the candidate documents have respective first relevance scores and the method further comprises:
determining, for the candidate documents, respective visual similarity scores based on the query image; and
boosting the respective first relevance scores based on the respective visual similarity scores,
wherein the highest ranking candidate documents are further ranked based on respective second relevance scores determined based on similarity with the context query and the respective first relevance scores.

5. The method of claim 1, wherein the context query is generated from terms most relevant to the query image.

6. The method of claim 1, wherein the candidate documents are filtered using a document quality threshold prior to ranking.

7. A method comprising:
receiving a request for context about an image;
providing the image to an image context service;
receiving a search result from the image context service in response to providing the image, the search result being based on a ranking of documents that have images semantically or visually similar to the image and a relevance to a context query related to the image; and
displaying the image and the search result.

8. The method of claim 7, wherein a source document associated with the image is provided to the image context service and the source document includes salient terms that are used to generate the context query.

9. The method of claim 7, wherein the ranking is further based on relevance to a stock-image query.

10. The method of claim 7, wherein receiving the request occurs responsive to selection of an interactive control provided on an image search result page that includes the image.

11. The method of claim 7, wherein receiving the request occurs responsive to selection of an interactive control provided on an image search application.

12. A method comprising:
generating a context query for a query image from terms describing the query image that are obtained from a generative model provided the query image as input;
identifying candidate documents responsive to the context query from a document index;
ranking the candidate documents based on similarity to the context query to identify highest ranking candidate documents; and
providing information about the query image based on the highest ranking candidate documents.

13. The method of claim 12, wherein the terms are first terms, and generating the context query further comprises:
identifying a second image that is similar to the query image, the second image being associated with second terms; and
using the second terms in further generating the context query.

14. The method of claim 13, wherein the second image is visually similar to the query image.

15. The method of claim 13, wherein generating the context query further comprises:
clustering the first terms and the second terms to generate a semantic cluster; and
including a description term representing the semantic cluster in the context query.

16. The method of claim 13, wherein generating the context query further comprises:
determining that a first semantic cluster relates to a first number of the first terms and the second terms and a second semantic cluster relates to a second number of the first terms and the second terms, the second number being lower than the first number; and
weighting the first semantic cluster higher than the second semantic cluster for inclusion in the context query.

17. The method of claim 12, wherein determining the candidate documents further includes identifying documents with images semantically similar to the query image from an image index.

18. The method of claim 17, wherein the candidate documents are first candidate documents and the method further comprises:
determining, for the first candidate documents with images semantically similar to the query image, second candidate documents, the second candidate documents meeting a relevance threshold for a stock-image query;
filtering out documents from the second candidate documents in response to determining the documents lack an image that meets a visual similarity threshold with the query image; and
including the second candidate documents with the first candidate documents as part of determining highest-ranking documents.

19. The method of claim 12, wherein the candidate documents further include documents from a fact-check repository that include an image similar to the query image.

20. The method of claim 17, wherein the candidate documents have respective first relevance scores and the method further comprises:
determining, for the candidate documents, respective visual similarity scores based on the query image; and
boosting the respective first relevance scores based on the respective visual similarity scores,
wherein the highest ranking candidate documents are further ranked based on respective second relevance scores determined based on similarity with the context query and the respective first relevance scores.
